(19) United States
(12) Patent Application Publication
(10) Pub. No.: US 2026/0177442 A1
(43) Pub. Date: Jun. 25, 2026

(54) REAL EAR SOUND PRESSURE LEVEL MEASUREMENT FOR A HEARING DEVICE

(71) Applicant: Starkey Laboratories, Inc., Eden Prairie, MN (US)

(72) Inventors: Anthony Karlsson Mangio, Eden Prairie, MN (US); Henning Schepker, Oldenburg (DE); Piero Iared Rivera Benois, Eden Prairie (DE); Kyle Olson, St. Louis Park, MN (US)

(21) Appl. No.: 19/422,177

(22) Filed: Dec. 16, 2025

Related U.S. Application Data
(60) Provisional application No. 63/736,999, filed on Dec. 20, 2024.

(51) Int. Cl. G01L 11/02; H04R 25/00

(52) U.S. Cl. CPC G01L 11/02; H04R 25/00

(57) ABSTRACT

Disclosed herein, among other things, are systems and methods for sound pressure level measurement for hearing devices. Various aspects include a method for sound pressure level measurement using self-mixing interferometry. The method includes directing a coherent light signal towards an eardrum of a user using an optical generation device, directing an audio signal towards the eardrum of the user using an audio generation device, and sensing a reflected light signal from the eardrum of the user using an optical sensor device. Displacement of the eardrum caused by the audio signal is computed using the reflected light signal, and real ear sound pressure level (SPL) at the eardrum is computed based on the displacement of the eardrum.

### CLAIM OF PRIORITY AND INCORPORATION BY REFERENCE

The present application claims the benefit under 35 U.S.C. § 119 (e) of U.S. Provisional Patent Application 63/736,999, filed Dec. 20, 2024, the disclosure of which is hereby incorporated by reference herein in its entirety.

### TECHNICAL FIELD

This document relates generally to hearing device systems and more particularly to systems and methods for real ear sound pressure level measurement using self-mixing interferometry.

### BACKGROUND

Audio devices can be used to provide audible output to a user based on received wireless signals. Examples of audio devices include speakers and ear-wearable devices, also referred to herein as hearing devices. Example of hearing devices include hearing assistance devices or hearing instruments, including both prescriptive devices and non-prescriptive devices. Specific examples of hearing devices include, but are not limited to, hearing aids, headphones, and earbuds.

Hearing aids are used to assist patients suffering hearing loss by transmitting amplified sounds to ear canals. In one example, a hearing aid is worn in and/or around a patient's ear. Hearing aids may include processors and electronics that improve the listening experience for a specific wearer or in a specific acoustic environment.

Hearing aid fitting and parameter adjustment may be dependent upon acoustic pressure at a wearer's eardrum while wearing the hearing aid. Improved methods of estimating eardrum acoustic pressure are needed.

### SUMMARY

Disclosed herein, among other things, are systems and methods for real ear sound pressure level measurement for hearing devices. Various aspects include a system for sound pressure level measurement. The system includes an optical generation device configured to direct a coherent light signal towards an eardrum of a user, an optical sensor device configured to sense a reflected light signal from the eardrum of the user, and an audio generation device configured to direct an audio signal towards the eardrum of the user. The system also includes at least one processor configured to direct the coherent light signal towards the eardrum using the optical generation device, direct the audio signal towards the eardrum using the audio generation device, sense the reflected light signal using the optical sensor device, compute displacement of the eardrum caused by the audio signal using the reflected light signal, and compute real ear sound pressure level (SPL) at the eardrum based on the displacement of the eardrum.

Various aspects include a method for sound pressure level measurement using self-mixing interferometry. The method includes directing a coherent light signal towards an eardrum of a user using an optical generation device, directing an audio signal towards the eardrum of the user using an audio generation device, and sensing a reflected light signal from the eardrum of the user using an optical sensor device. Displacement of the eardrum caused by the audio signal is computed using the reflected light signal, and real ear SPL at the eardrum is computed based on the displacement of the eardrum.

This Summary is an overview of some of the teachings of the present application and not intended to be an exclusive or exhaustive treatment of the present subject matter. Further details about the present subject matter are found in the detailed description and appended claims.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1A illustrates a perspective view of a system for real ear sound pressure level measurement, according to various examples of the present subject matter.

FIG. 1B illustrates a graphical diagram a signal sensed by the system of FIG. 1A, according to various examples of the present subject matter.

FIG. 2A illustrates a circuit diagram of a system for real ear sound pressure level measurement using self-mixing interferometry, according to various examples of the present subject matter.

FIG. 2B illustrates a graphical diagram a signal used by the system of FIG. 2A, according to various examples of the present subject matter.

FIG. 3 illustrates a flow diagram of a method for sound pressure level measurement using self-mixing interferometry, according to various examples of the present subject matter.

FIG. 4A illustrates a block diagram of a hearing device circuit, according to various examples of the present subject matter.

FIG. 4B illustrates a block diagram of an example machine upon which any one or more of the techniques discussed herein may perform.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment, including combinations of such embodiments. The following detailed description is demonstrative and not to be taken in a limiting sense. The scope of the present subject matter is defined by the appended claims, along with the full scope of legal equivalents to which such claims are entitled.

The present detailed description will discuss audio devices such as hearing devices and speakers. The description refers to hearing devices or hearing instruments generally, which include earbuds, headsets, headphones, and hearing assistance devices using the example of hearing aids. Other hearing devices include, but are not limited to, those in this document. It is understood that their use in the description is intended to demonstrate the present subject matter, but not in a limited or exclusive or exhaustive sense.

Audiological best-practices call for measurement of sound pressure level (SPL) when fitting a hearing device, such as a hearing aid. In one example, measurement of the hearing aid user's estimated real-ear aided response (REAR) is performed in each ear to be fitted with a hearing aid. These measurements traditionally require the use of an expensive dedicated apparatus for a real-ear measurement system by trained professionals or audiologists, who insert a probe tube equipped with a microphone inside the user's ear canal, in close proximity to the eardrum, with the hearing aid inserted into the ear. These measurements can be time consuming, delicate and potentially painful for the patient if the eardrum is touched during insertion of the probe tube.

One previous alternative to measuring REARs with a dedicated probe tube system is to measure them using a hearing aid or audio device featuring an in-the-canal microphone. However, the vast majority of hearing devices do not feature a microphone inside the ear canal. Adding such a microphone into the design of these hearing devices is not always possible and, even when possible, usually results in increased production costs and other consequences such as less room for other components on the in-the-canal part of the device, and potential issues during use related to cerumen getting in or on the in-the-canal microphone. This present subject matter solves the above problems by making it possible to obtain SPLs and REARs without requiring the use of a probe-tube or in-the-ear-canal microphone.

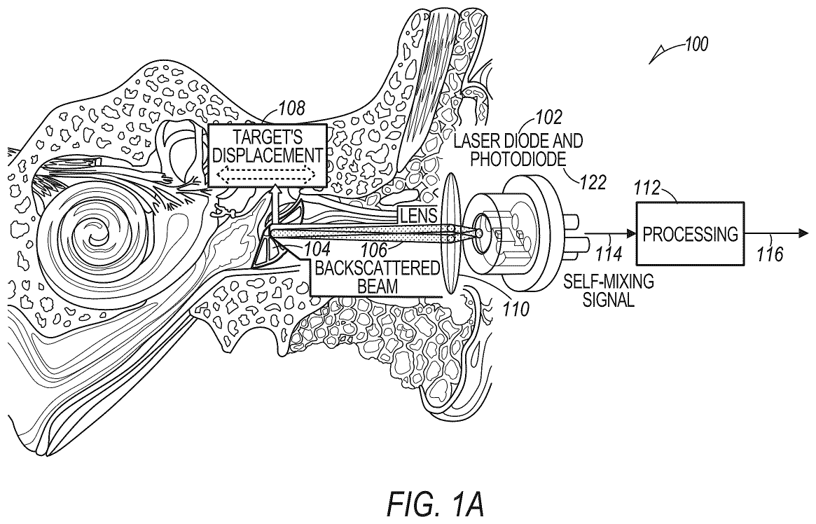

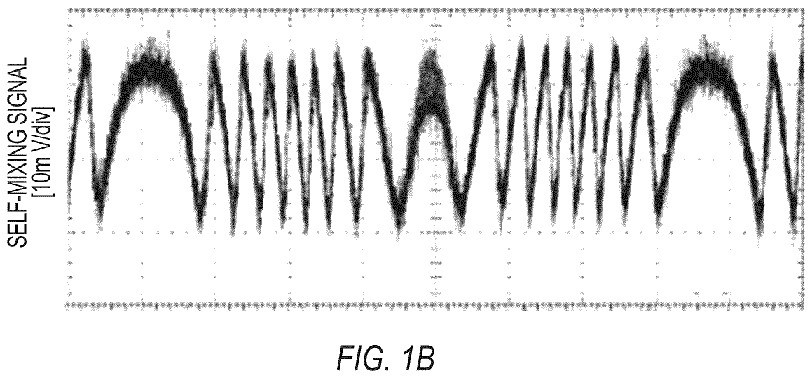

FIG. 1A illustrates a perspective view of a system for real ear sound pressure level measurement, according to various examples of the present subject matter. The system 100 includes an optical generation device 102 configured to direct a coherent light signal towards an eardrum 104 of a user, an optical sensor device 122 configured to sense a reflected light signal 106 from the eardrum of the user, and an audio generation device (not shown) configured to direct an audio signal towards the eardrum of the user. The system also includes at least one processor 112 configured to direct the coherent light signal towards the eardrum using the optical generation device, direct the audio signal towards the eardrum using the audio generation device, sense the reflected light signal using the optical sensor device, compute displacement 108 of the eardrum caused by the audio signal using the reflected light signal, and compute real ear sound pressure level (SPL) 116 at the eardrum based on the displacement of the eardrum, such as by using self-mixing signal 114. A lens 110 may be used to focus or direct the coherent light signal, in various examples.

In various examples, the optical generation device 102 includes a light amplification by stimulated emission of radiation (LASER) diode. The optical sensor device 122 includes a photodiode, in various examples. According to various examples, the audio generation device includes a speaker or receiver. In some examples, the speaker or receiver may be incorporated into a hearing device, such as a hearing aid, and the user is a wearer of the hearing device. In various examples, the optical generation device, the optical sensor device and/or the processor may be incorporated into a hearing device. The processor or processors may be further configured to process audio signals to correct for a hearing impairment of the user of the hearing device, in some examples.

The system 100 may also include an analog-to-digital converter (ADC) configured to convert the reflected light signal from analog to digital for displacement computation, in some examples. In various examples, the optical generation device is configured to direct the coherent light signal towards an approximate center portion of the eardrum of the user. FIG. 1B illustrates a graphical diagram a signal, such as self-mixing signal 114, sensed by the system of FIG. 1A, according to various examples of the present subject matter.

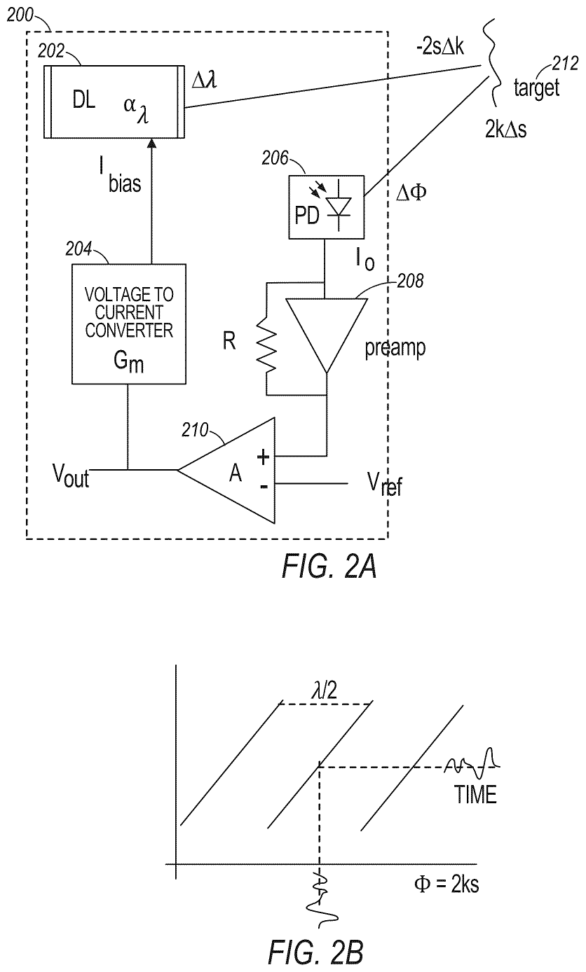

FIG. 2A illustrates a circuit diagram of a system for real ear sound pressure level measurement using self-mixing interferometry, according to various examples of the present subject matter. The system 200 includes a laser diode 202 and a photodiode 206, as described above with respect to FIG. 2A. The depicted embodiment utilizes half fringe stabilized interferometry to determine SPL using the diodes. In various examples, the laser diode 202 is configured to direct a coherent light signal towards a target 212, such as an eardrum of a user, and the photodiode 206 is configured to sense a reflected light signal from the target 212. The output of the photodiode 206 is passed through a pre-amplifier 208 and amplifier 210, in various examples. In some examples, the output of the amplifier 210 is input into a voltage-to-current converter 204, the output of which is used to bias the laser diode 202. FIG. 2B illustrates a graphical diagram a signal used by the system of FIG. 2A, according to various examples of the present subject matter.

According to various examples, this system and method provide for a laser diode and photodiode placed within the ear canal and directed at the eardrum surface. The laser diode is powered on, and the system verifies that no noise is present at the eardrum. After calibrating a location of zero displacement, sound is injected causing the eardrum to vibrate. As the eardrum vibrates the laser causes constructive and destructive interference to be absorbed by the laser diode. The power emitted by the laser diode is modulated both in amplitude and frequency generating a fringe interferometric signal which may be used to estimate the distance to the target and associated displacement, in various examples. The photodiode is used to measure the power emitted by the laser diode and outputs the self-mixing signal back to the ADC to be converted and digitally reconstructed as the eardrum displacement. The magnitude of the total displacement is used to determine SPL, in various examples. In some examples, the beam is directed toward the center of the eardrum and the vibration movement measured, such as by using an alternating current (AC) waveform.

In various examples, the laser diode is directed towards the center of the eardrum to provide maximum displacement, such as by performing an optimization to find the maximum displacement (e.g., gradient descent, genetic algorithm, particle swarm, etc.) and then focusing the laser beam. In one example, the system may use phased-array beam steering, such as by varying the laser phase delay through several lenses 110 to direct the laser wavefront towards the eardrum target without requiring any mechanical mechanisms. In another example, the system may use a micro-electro-mechanical system (MEMS) based micromirror or microlens to provide a mechanism to steer the laser wavefront. In a further example, the system may use a fiber optic cable extension with control surfaces analogous to a concentric tube robot to provide a mechanism to steer the laser wavefront. In yet another example, the system may use a custom mold or housing that can ensure precise placement of the components of the present system in the ear canal to ensure the laser points directly at the target location on the eardrum.

According to various examples, the present system may be configured to overcome obstructions (hair, ear wax, bends in the ear canal, etc.) that prevent direct line of sight between the laser diode and the target location, and which may inhibit or prevent targeting of the laser and measurement of displacement. In one example, the system may overcome all types of blockages using a fiber optic cable extension placed within the ear to decrease the distance to the eardrum and provide a wide field of view over the eardrum target. In another example, to overcome a small amount of wax blockage, the system may increase intensity of the laser beam and melt the wax blockage. In a further example, the system may use custom mold hearing aids to allow for the direct line of sight to the eardrum. In an additional example, the system may use a lensing system configured to spread the laser light over the entire convex surface of the eardrum to bypass the ear wax and hair obstructions. In still a further example, the system may use multiple lasers to form an array to measure the displacement over an area rather than a single point on the eardrum, to overcome obstructions.

In some examples, the system may be used as a sensor input for active noise control, active occlusion control and other algorithms that require an in-eardrum vibration measurement. In various examples, the system may use a reflective material applied to the face of the eardrum to allow more back-scattering to the laser cavity. The system may include a de-vibration coupling mechanism by splitting the laser beam to reflect from the side wall of the ear canal to change the fringe self-mixing signal in such a way that would subtract the vibration from the ear canal from the eardrum movement, in some examples. The system may use a half fringe stabilization methodology to provide negative feedback to the system to allow for the linearization of measurement over half a wavelength of the laser used, in various examples. In one example, this measurement encompasses the entire displacement of the eardrum while maintaining a 10-30 picometer resolution. In some examples, the present subject matter may use frequency modulation (FM) self-mixing laser interferometry.

According to some examples, the present system may be integrated into hearing aids and does not interfere with the acoustic pathway during the real ear SPL measurement. The system uses lasers to measure the true displacement of the eardrum to correlate to real ear SPL, in various examples. Previously, measurement of real ear SPL was done using a microphone at the eardrum. However, the microphone can only estimate the displacement of the eardrum and cannot monitor the true movement of the tympanic membrane.

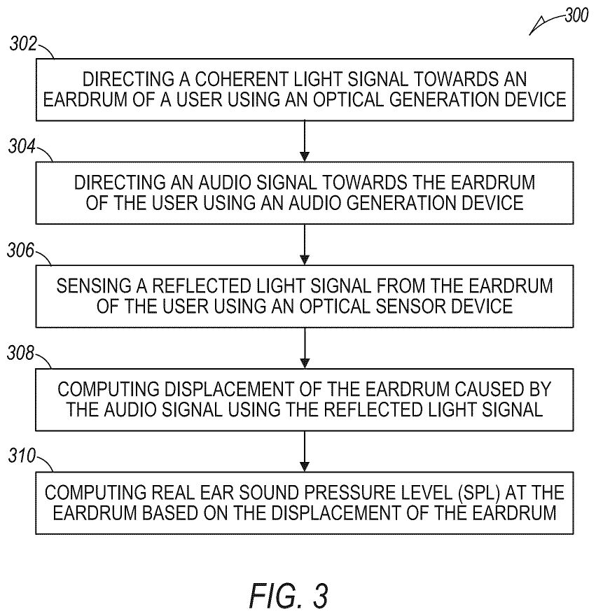

FIG. 3 illustrates a flow diagram of a method for sound pressure level measurement using self-mixing interferometry, according to various examples of the present subject matter. The method 300 includes directing a coherent light signal towards an eardrum of a user using an optical generation device, at step 302. At step 304, an audio signal is directed towards the eardrum of the user using an audio generation device. A reflected light signal from the eardrum of the user is sensed using an optical sensor device, at step 306. At step 308, displacement of the eardrum caused by the audio signal is computed using the reflected light signal. Real ear sound pressure level (SPL) at the eardrum is computed based on the displacement of the eardrum, at step 310.

In various examples, directing the coherent light signal includes directing the coherent light signal towards an approximate center portion of the eardrum of the user using the optical generation device, such as by performing an optimization to determine a location of maximum displacement of the eardrum and applying a phased-array beam steering using the location of maximum displacement. In some examples, directing the coherent light signal towards an approximate center portion of the eardrum includes using a micro-electromechanical system (MEMS) based microlens steering using the location of maximum displacement. In other examples, directing the coherent light signal towards an approximate center portion of the eardrum includes using a fiber optic cable extension for steering using the location of maximum displacement. The fiber optic cable extension is configured to be placed within an ear of the user to bypass obstructions within the ear, in one example.

According to various examples, the method 300 may further include increasing an intensity of the coherent light signal to pass through obstructions within an ear of the user. The method 300 may further include using a lensing system to spread the coherent light signal to avoid obstructions within an ear of the user, in some examples. In other examples, the method 300 may further include using multiple coherent light signals to avoid obstructions within an ear of the user.

The method 300 may further include using the computed displacement of the eardrum as an input for a hearing device parameter optimizer configured to match the computed displacement with a target displacement of the eardrum, in some examples. The hearing device parameter optimizer is further configured to optimize at least one hearing device parameter based on estimated deviations between an effective hearing device gain and a prescribed hearing device gain, in one example. In various examples, the method 300 may further include using the computed displacement of the eardrum as an input for active noise control of a hearing device. In other examples, the method 300 may also include using the computed displacement of the eardrum as an input for active occlusion control of a hearing device.

Various examples of the method 300 may further include sensing a reflected signal from an ear canal wall of the user using the optical sensor device, measuring a bone-conducted voice component of the user using the reflected signal, and using the measured bone-conducted voice component to enhance performance of the active occlusion control of the hearing device. In some examples, the method 300 may further include applying a reflective material to a face of the eardrum to provide an improved reflected light signal. The method 300 may further include using a de-vibration coupling mechanism including splitting the coherent light signal to reflect from a side wall of an ear canal of the user, in some examples. In other examples, the method 300 may further include using a half fringe stabilization system to provide negative feedback for linearization of measurement over a half wavelength of the coherent light signal.

The present system provides for the measurement of real ear SPL by using a self-mixing interferometry measurement methodology to measure the change in depth of the eardrum displacement over time. The system provides many benefits, including providing for measuring the SPL without requiring a microphone to be placed at the eardrum. By using self-mixing interferometry, the system can accurately measure how much the eardrum displaces over time without interfering with the acoustic pathway. This system can also be integrated into a hearing aid and be used to measure real ear SPL at the eardrum. This measurement is useful for measuring unsafe hearing levels and may be used as an algorithm (ex. active noise cancelling) input for the hearing aid. Previously, a microphone was placed at the eardrum to gather real ear SPL information. By using the present system, a laser can be placed away from the eardrum leading to increased patient comfort and increased diagnostic speed. In addition, the present system provides direct measurement of the eardrum moment for hearing aids for active noise cancelling and other algorithms for hearing aids and other devices.

In various examples, the present system determines how the eardrum moves in response to sound, as the eardrum vibrates when sound waves hit it, which is the first step in converting sound waves into nerve impulses. Change in depth of this eardrum movement or physical displacement over time is measured by the system, in various examples.

Various light colors may be used with the present optical light generation. In some examples, the color is determined to optimize measurement of eardrum displacement. For example, longer wavelengths do not reflect as well over the relatively short distances, but provide for finer measurement. In contrast, shorter wavelengths may reflect better but do not provide as fine a measurement. In some examples, multiple wavelengths may be used in parallel to provide benefits of each color used, such as by using multiple sources. In various examples, coherence of the generated light signal is limited to a single wavelength to provide for self-mixing.

In various examples, the present system limits power used by the generated coherent light signal to avoid damage to the eardrum. In some examples, the generated coherent light signal is not used continuously, but only periodically or on a scheduled basis to preserve battery power for the system. In one example, an off-the-shelf laser diode on a die is used by the system, such as a 0.1 mW diode, so power use is minimized. The system is calibrated before using the diodes to measure SPL, in various examples. The present system may be used to detect unsafe levels of noise for the eardrum or for a microphone, in some examples. In other examples, the present system may be used for noise cancelling, and hence may be updated more frequently. Because the present system uses an actual measurement of eardrum displacement, the system reduces compensation errors compared to previous solutions. In addition, the present SPL measurement system provides for faster computation, because there is less delay in the laser signal than compared to previously-used acoustic travel time.

The present subject matter may be used in all situations in which a hearing aid or other in-the-ear device is placed in a user's ear, and some of its parameters (e.g., amplification gains) are adjusted automatically, taking into account the individual acoustic characteristics of the user's ear, such as characteristics of the residual ear canal with the hearing aid or audio device in place inside the ear.

In one example, the present subject matter may be used during hearing aid fitting, e.g., for automatic adjustment of hearing aid parameters such as amplification gains, in-situ audiometry stimulus levels, tinnitus masker band levels, etc., according to the hearing aid user's REAR or SPL measured as described herein. In this context, a major advantageous feature of the present subject matter is that it makes it unnecessary for a clinician to perform measurements using a separate, dedicated, expensive real-ear measurement system, including a probe tube.

Eardrum sound-pressure and/or vent-effect levels obtained using the present subject matter can be used to automatically adjust parameters of the user's hearing aid, including but not limited to: amplification gains, low-frequency amplification applied to audio signals streamed into the hearing aid from another audio device, acoustic stimulus level for in-situ audiometry, or tinnitus-stimulus for acoustic therapy for tinnitus. Such automated adjustment of gains based on individual eardrum sound pressure can provide various benefits during the hearing aid fitting process, including but not limited to: automated individualized adjustments of hearing aid gains, and automated adjustment of stimulus levels during in-situ audiometry. In addition, the automated adjustments can be advantageous subsequent to the fitting process, by providing improved audio sound quality, improved loudness comfort, improved speech understanding, and improved tinnitus-masker efficacy/efficiency. Further, the present subject matter may be combined with a perceptual hearing threshold measurement.

REARs refer to measurements of pressure inside the ear canal, with the hearing aid positioned inside the ear as it would during normal use, as opposed to real-ear unaided responses (REURs), which are measured with the user's ear canal unobstructed by a hearing aid. Previously, REARs were measured using a probe-tube equipped with a microphone, which is inserted into the ear canal between 3 and 15 mm from the eardrum.

As provided herein, a vent effect is the difference in sound pressure inside the ear canal, with the device in place, relative to some reference condition (e.g., completely occluded ear canal or completely open ear canal). The term ‘vent’ should not be interpreted to mean solely a vent in the traditional sense of an opening in a custom hearing aid, but rather any acoustic opening or leakage, such as might occur, for instance, in a receiver-in-canal (RIC) hearing-aid equipped with a stock earbud.

Maximum stable gains (MSGs), also referred to as “added stable gains” (ASGs) or “gain margins”, designate the highest sound amplification gains that can be achieved by a hearing device positioned in the ear canal, without triggering a significant acoustic feedback signal resulting from an electro-acoustic loop between the receiver or body of the device and one of the microphones on the device, that cannot be effectively suppressed by the feedback canceller (FBC) system. MSGs are usually measured after the device is inserted into the ear canal for the first time by a professional hearing care provider or by the user himself, during a process commonly referred to as “FBC initialization”. This FBC initialization process is usually performed at least once prior to the initial adjustment (usually, performed by a hearing care professional) of certain hearing aid parameters, such as, in particular, the gains for sound amplification delivered by the device into the user's ear. In addition, MSGs can be measured or estimated at other times. For example, MSGs can be measured or estimated periodically after the initial fitting, either just after the user puts the hearing aid or audio device into his ear or while the devices are being used and running the FBC (e.g., the adaptive filter used in the feedback cancellation algorithm).

In various examples, the present subject matter may use hardware external to or separate from a hearing device. In various examples, the present subject matter may use hardware on or in a hearing device. In various examples, the present subject matter may use hardware on or in a hearing device and hardware external to or separate from a hearing device. The present subject matter may be implemented in a hearing aid or an earbud or any ear-worn device, in various examples. Various types of hearing devices may be used with the present SPL measurement system, including but not limited to hearing aids.

According to various examples, the present system processes collected data using a processor in or on the hearing device. Other processors may be used, such as in remote devices (e.g., in a smartphone) that are in communication with the hearing device. The logged data may be stored locally on the hearing device or remotely, such as on cloud storage, or using an application on mobile device. In some examples, the present system uses machine learning, including but not limited to a deep neural network or artificial intelligence, to process the tracked data. The machine learning processor, either local or remote, may be trained on data from the user and/or data from multiple users or participants.

In some examples, the present method provides notification to the user via the hearing device or in a smartphone application associated with the hearing device. The present method may also or alternatively provide notifications to a healthcare provider of the user, such that the user's doctor or other individual (such as another health care provider, family member, or the like) may also keep track of patient data.

In some examples, the sensor data is logged in a hearing device. The sensor data may be logged in external devices or in the cloud, in various examples. In various examples, the present method and system may be programmed into firmware of the device. In other examples, a separate program or device may be used to track and record the sensor data for the user.

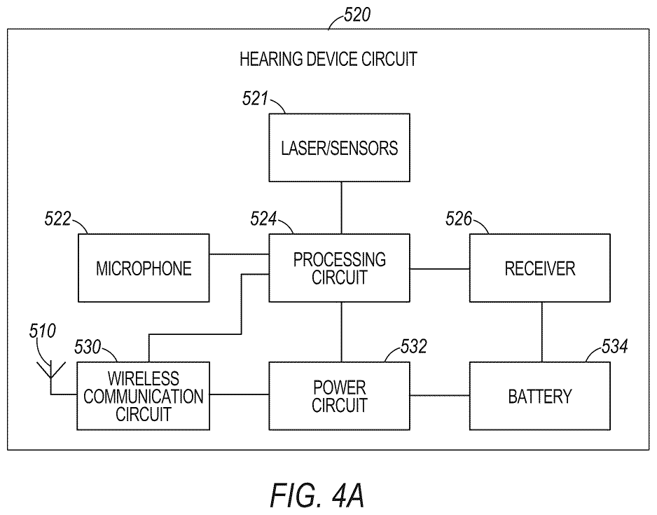

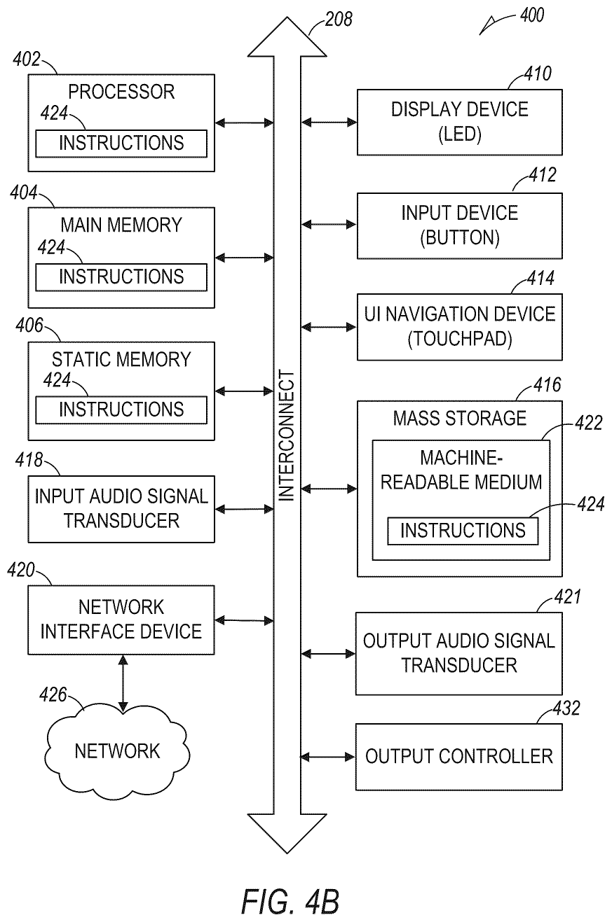

FIG. 4A illustrates a block diagram of a hearing device circuit, according to various examples of the present subject matter. Hearing device circuit 520 represents an example of portions of a hearing device and includes a microphone 522, a wireless communication circuit 530, an antenna 510, one or more optical generation and/or optical sensor devices, such as laser/sensors 521, a processing circuit 524, a receiver (speaker) 526, a battery 534, and a power circuit 532. Microphone 522 receives sounds from the environment of the hearing device user (wearer of the hearing device). Wireless communication circuit 530 communicates with another device wirelessly using antenna 510, including receiving programming codes, streamed audio signals, and/or other audio signals and transmitting programming codes, audio signals, and/or other signals. Examples of the other device includes other hearing devices of other users, another hearing device of a pair of hearing devices for the same wearer, a hearing device host device, an assistive listening device (ALD), an audio streaming device, a smartphone, and other devices capable of communicating with hearing devices wirelessly. Processing circuit 524 controls the operation of a hearing device using the programming codes and processes the sounds received by microphone 522 and/or the audio signals received by wireless communication circuit 530 to produce output sounds. Receiver 526 transmits output sounds to an ear canal of the hearing device wearer. Battery 534 and power circuit 532 constitute the power source for the operation of hearing device circuit 520. In one example, power circuit 532 can include a power management circuit. In another alternative or additional example, battery 534 can include a rechargeable battery and power circuit 532 can include a recharging circuit for recharging the rechargeable battery.

In various examples, the hearing device is configured to provide sound pressure level measurement using self-mixing interferometry. The hearing device circuit 520 may include an optical generation device (laser/sensors 521) configured to direct a coherent light signal towards an eardrum of a user, an optical sensor device (laser/sensors 521) configured to sense a reflected light signal from the eardrum of the user, and an audio generation device (receiver 526) configured to direct an audio signal towards the eardrum of the user.

The hearing device circuit 520 includes at least one processor or processing circuit 524 and data storage in communication with the processing circuit 524. The data storage comprises instructions thereon that, when executed by the processing circuit 524, causes the processing circuit 524 to perform the functions of the present systems and methods, such as the method depicted in FIG. 3. For example, the processing circuit may perform operations to direct the coherent light signal towards the eardrum using the optical generation device, direct the audio signal towards the eardrum using the audio generation device, sense the reflected light signal using the optical sensor device, compute displacement of the eardrum caused by the audio signal using the reflected light signal, and compute real ear sound pressure level (SPL) at the eardrum based on the displacement of the eardrum. The hearing device circuit 520 may be included in an ear bud, headphones, a hearing aid, or other ear-wearable device, in various examples.

FIG. 4B illustrates a block diagram of an example machine 400 upon which any one or more of the techniques (e.g., methodologies) discussed herein may perform. In alternative examples, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a hearing device, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 400 may include a hardware processor 402 (e.g., a central processing unit (CPU), a graphics processing unit (GPU), a hardware processor core, or any combination thereof), a main memory 404, and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, input device 412, and UI navigation device 414 may be a touch screen display. The machine 400 may additionally include a storage device (e.g., drive unit) 416, one or more input audio signal transducers 418 (e.g., microphone), a network interface device 420, and one or more output audio signal transducers 421 (e.g., speaker). The machine 400 may include an output controller 432, such as a serial (e.g., universal serial bus (USB), parallel, or other wired or wireless (e.g., infrared (IR), near-field communication, etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to communicate wirelessly using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 400, and includes digital or analog communications signals or other intangible medium to facilitate communication of such software.

Various examples of the present subject matter support wireless communications with a hearing device. In various examples the wireless communications may include standard or nonstandard communications. Some examples of standard wireless communications include link protocols including, but not limited to, Bluetooth™, BLE, Auracast, IEEE 802.11 (wireless LANs), 802.15 (WPANs), 802.16 (WiMAX), cellular protocols including, but not limited to CDMA and GSM, ZigBee, and ultra-wideband (UWB) technologies. Such protocols support radio frequency communications and some support infrared communications while others support NFMI. Although the present system is demonstrated as a radio system, it is possible that other forms of wireless communications may be used such as ultrasonic, optical, infrared, and others. It is understood that the standards which may be used include past and present standards. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, SPI, PCM, ATM, Fibre-channel, Firewire or 1394, InfiniBand, or a native streaming interface. In various examples, such connections include all past and present link protocols. It is also contemplated that future versions of these protocols and new future standards may be employed without departing from the scope of the present subject matter.

Hearing assistance devices typically include at least one enclosure or housing, a microphone, hearing assistance device electronics including processing electronics, and a speaker or “receiver.” Hearing assistance devices may include a power source, such as a battery. In various examples, the battery is rechargeable. In various examples multiple energy sources are employed. It is understood that in various examples the microphone is optional. It is understood that in various examples the receiver is optional. It is understood that variations in communications protocols, antenna configurations, and combinations of components may be employed without departing from the scope of the present subject matter. Antenna configurations may vary and may be included within an enclosure for the electronics or be external to an enclosure for the electronics. Thus, the examples set forth herein are intended to be demonstrative and not a limiting or exhaustive depiction of variations.

It is understood that digital hearing assistance devices include a processor. In digital hearing assistance devices with a processor, programmable gains may be employed to adjust the hearing assistance device output to a wearer's particular hearing impairment. The processor may be a digital signal processor (DSP), microprocessor, microcontroller, other digital logic, or combinations thereof. The processing may be done by a single processor, or may be distributed over different devices. The processing of signals referenced in this application may be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, buffering, and certain types of filtering and processing. In various examples of the present subject matter the processor is adapted to perform instructions stored in one or more memories, which may or may not be explicitly shown. Various types of memory may be used, including volatile and nonvolatile forms of memory. In various examples, the processor or other processing devices execute instructions to perform a number of signal processing tasks. Such examples may include analog components in communication with the processor to perform signal processing tasks, such as sound reception by a microphone, or playing of sound using a receiver (i.e., in applications where such transducers are used). In various examples of the present subject matter, different realizations of the block diagrams, circuits, and processes set forth herein may be created by one of skill in the art without departing from the scope of the present subject matter.

It is further understood that different hearing devices may embody the present subject matter without departing from the scope of the present disclosure. The devices depicted in the figures are intended to demonstrate the subject matter, but not necessarily in a limited, exhaustive, or exclusive sense. It is also understood that the present subject matter may be used with a device designed for use in the right ear or the left ear or both ears of the wearer.

The present subject matter is demonstrated for hearing devices, including hearing assistance devices, including but not limited to, behind-the-ear (BTE), in-the-ear (ITE), in-the-canal (ITC), receiver-in-canal (RIC), invisible-in-canal (IIC) or completely-in-the-canal (CIC) type hearing assistance devices. It is understood that behind-the-ear type hearing assistance devices may include devices that reside substantially behind the ear or over the ear. Such devices may include hearing assistance devices with receivers associated with the electronics portion of the behind-the-ear device, or hearing assistance devices of the type having receivers in the ear canal of the user, including but not limited to RIC or receiver-in-the-ear (RITE) designs. The present subject matter may also be used in hearing assistance devices generally, such as cochlear implant type hearing devices. The present subject matter may also be used in deep insertion devices having a transducer, such as a receiver or microphone. The present subject matter may be used in bone conduction or otherwise osseointegrated hearing devices, in some examples. The present subject matter may be used in devices whether such devices are standard or custom fit and whether they provide an open or an occlusive design. It is understood that other hearing devices not expressly stated herein may be used in conjunction with the present subject matter.

### Other Notes and Examples

Example 1 is a system including an optical generation device configured to direct a coherent light signal towards an eardrum of a user, an optical sensor device configured to sense a reflected light signal from the eardrum of the user, an audio generation device configured to direct an audio signal towards the eardrum of the user, and at least one processor configured to: direct the coherent light signal towards the eardrum using the optical generation device, direct the audio signal towards the eardrum using the audio generation device, sense the reflected light signal using the optical sensor device, compute displacement of the eardrum caused by the audio signal using the reflected light signal, and compute real ear sound pressure level (SPL) at the eardrum based on the displacement of the eardrum.

In Example 2, the subject matter of Example 1 optionally includes wherein the optical generation device includes a light amplification by stimulated emission of radiation (LASER) diode.

In Example 3, the subject matter of any of Examples 1-2 optionally includes wherein the optical sensor device includes a photodiode.

In Example 4, the subject matter of any of Examples 1-3 optionally includes wherein the audio generation device includes a speaker or receiver.

In Example 5, the subject matter of Example 4 optionally includes wherein the speaker or receiver is incorporated into a hearing device.

In Example 6, the subject matter of Example 5 optionally includes wherein the hearing device is a hearing aid.

In Example 7, the subject matter of Example 5 optionally includes wherein the user is a wearer of the hearing device.

In Example 8, the subject matter of any of Examples 1-7 optionally includes wherein the optical generation device is incorporated into a hearing device.

In Example 9, the subject matter of any of Examples 1-8 optionally includes wherein the optical sensor device is incorporated into a hearing device.

In Example 10, the subject matter of any of Examples 1-9 optionally includes wherein the at least one processor is incorporated into a hearing device.

In Example 11, the subject matter of Example 10 optionally includes wherein the at least one processor is further configured to process audio signals to correct for a hearing impairment of the user of the hearing device.

In Example 12, the subject matter of any of Examples 1-11 optionally further includes an analog-to-digital converter (ADC) configured to convert the reflected light signal from analog to digital for displacement computation.

In Example 13, the subject matter of any of Examples 1-12 optionally includes wherein the optical generation device is configured to direct the coherent light signal towards an approximate center portion of the eardrum of the user.

Example 14 is a method including directing a coherent light signal towards an eardrum of a user using an optical generation device, directing an audio signal towards the eardrum of the user using an audio generation device, sensing a reflected light signal from the eardrum of the user using an optical sensor device, computing displacement of the eardrum caused by the audio signal using the reflected light signal, and computing real ear sound pressure level (SPL) at the eardrum based on the displacement of the eardrum.

In Example 15, the subject matter of Example 14 optionally includes wherein directing the coherent light signal includes directing the coherent light signal towards an approximate center portion of the eardrum of the user using the optical generation device.

In Example 16, the subject matter of Example 15 optionally includes wherein directing the coherent light signal towards the approximate center portion of the eardrum includes performing an optimization to determine a location of maximum displacement of the eardrum.

In Example 17, the subject matter of Example 16 optionally includes wherein directing the coherent light signal towards the approximate center portion of the eardrum includes using a phased-array beam steering using the location of maximum displacement.

In Example 18, the subject matter of Example 16 optionally includes wherein directing the coherent light signal towards the approximate center portion of the eardrum includes using a micro-electromechanical system (MEMS) based microlens steering using the location of maximum displacement.

In Example 19, the subject matter of Example 16 optionally includes wherein directing the coherent light signal towards the approximate center portion of the eardrum includes using a fiber optic cable extension for steering using the location of maximum displacement.

In Example 20, the subject matter of Example 19 optionally includes wherein the fiber optic cable extension is configured to be placed within an ear of the user to bypass obstructions within the ear.

In Example 21, the subject matter of any of Examples 14-20 optionally further includes increasing an intensity of the coherent light signal to pass through obstructions within an ear of the user.

In Example 22, the subject matter of any of Examples 14-21 optionally further includes using a lensing system to spread the coherent light signal to avoid obstructions within an ear of the user.

In Example 23, the subject matter of any of Examples 14-22 optionally further includes using multiple coherent light signals to avoid obstructions within an ear of the user.

In Example 24, the subject matter of any of Examples 14-23 optionally further includes using the computed displacement of the eardrum as an input for a hearing device parameter optimizer configured to match the computed displacement with a target displacement of the eardrum.

In Example 25, the subject matter of Example 24 optionally includes wherein the hearing device parameter optimizer is further configured to optimize at least one hearing device parameter based on estimated deviations between an effective hearing device gain and a prescribed hearing device gain.

In Example 26, the subject matter of any of Examples 14-25 optionally further includes using the computed displacement of the eardrum as an input for active noise control of a hearing device.

In Example 27, the subject matter of any of Examples 14-26 optionally further includes using the computed displacement of the eardrum as an input for active occlusion control of a hearing device.

In Example 28, the subject matter of Example 27 optionally further includes: sensing a reflected signal from an ear canal wall of the user using the optical sensor device, measuring a bone-conducted voice component of the user using the reflected signal, and using the measured bone-conducted voice component to enhance performance of the active occlusion control of the hearing device.

In Example 29, the subject matter of any of Examples 14-28 optionally further includes applying a reflective material to a face of the eardrum to provide an improved reflected light signal.

In Example 30, the subject matter of any of Examples 14-29 optionally further includes using a de-vibration coupling mechanism including splitting the coherent light signal to reflect from a side wall of an ear canal of the user.

In Example 31, the subject matter of any of Examples 14-30 optionally further includes using a half fringe stabilization system to provide negative feedback for linearization of measurement over a half wavelength of the coherent light signal.

Example 32 is at least one machine-readable medium including instructions that, when executed by processing circuitry, cause the processing circuitry to perform operations to implement of any of Examples 1-31.

Example 33 is an apparatus comprising means to implement of any of Examples 1-31.

Example 34 is a system to implement of any of Examples 1-31.

Example 35 is a method to implement of any of Examples 1-31.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A system comprising:
an optical generation device configured to direct a coherent light signal towards an eardrum of a user;
an optical sensor device configured to sense a reflected light signal from the eardrum of the user;
an audio generation device configured to direct an audio signal towards the eardrum of the user; and
at least one processor configured to:
direct the coherent light signal towards the eardrum using the optical generation device;
direct the audio signal towards the eardrum using the audio generation device;
sense the reflected light signal using the optical sensor device;
compute displacement of the eardrum caused by the audio signal using the reflected light signal; and
compute real ear sound pressure level (SPL) at the eardrum based on the displacement of the eardrum.

2. The system of claim 1, wherein the optical generation device includes a light amplification by stimulated emission of radiation (LASER) diode.

3. The system of claim 1, wherein the optical sensor device includes a photodiode.

4. The system of claim 1, wherein the audio generation device includes a speaker or receiver.

5. The system of claim 4, wherein the speaker or receiver is incorporated into a hearing device.

6. The system of claim 5, wherein the hearing device is a hearing aid.

7. The system of claim 5, wherein the user is a wearer of the hearing device.

8. The system of claim 1, wherein the optical generation device is incorporated into a hearing device.

9. The system of claim 1, wherein the optical sensor device is incorporated into a hearing device.

10. The system of claim 1, wherein the at least one processor is incorporated into a hearing device.

11. The system of claim 10, wherein the at least one processor is further configured to:
process audio signals to correct for a hearing impairment of the user of the hearing device.

12. The system of claim 1, further comprising an analog-to-digital converter (ADC) configured to convert the reflected light signal from analog to digital for displacement computation.

13. The system of claim 1, wherein the optical generation device is configured to direct the coherent light signal towards an approximate center portion of the eardrum of the user.

14. A method comprising:
directing a coherent light signal towards an eardrum of a user using an optical generation device;
directing an audio signal towards the eardrum of the user using an audio generation device;
sensing a reflected light signal from the eardrum of the user using an optical sensor device;
computing displacement of the eardrum caused by the audio signal using the reflected light signal; and
computing real ear sound pressure level (SPL) at the eardrum based on the displacement of the eardrum.

15. The method of claim 14, wherein directing the coherent light signal includes directing the coherent light signal towards an approximate center portion of the eardrum of the user using the optical generation device.

16. The method of claim 15, wherein directing the coherent light signal towards the approximate center portion of the eardrum includes performing an optimization to determine a location of maximum displacement of the eardrum.

17. The method of claim 16, wherein directing the coherent light signal towards the approximate center portion of the eardrum includes using a phased-array beam steering using the location of maximum displacement.

18. The method of claim 16, wherein directing the coherent light signal towards the approximate center portion of the eardrum includes using a micro-electromechanical system (MEMS) based microlens steering using the location of maximum displacement.

19. The method of claim 16, wherein directing the coherent light signal towards the approximate center portion of the eardrum includes using a fiber optic cable extension for steering using the location of maximum displacement.

20. The method of claim 19, wherein the fiber optic cable extension is configured to be placed within an ear of the user to bypass obstructions within the ear.

21. The method of claim 14, further comprising increasing an intensity of the coherent light signal to pass through obstructions within an ear of the user.

22. The method of claim 14, further comprising using a lensing system to spread the coherent light signal to avoid obstructions within an ear of the user.

23. The method of claim 14, further comprising using multiple coherent light signals to avoid obstructions within an ear of the user.

24. The method of claim 14, further comprising using the computed displacement of the eardrum as an input for a hearing device parameter optimizer configured to match the computed displacement with a target displacement of the eardrum.

25. The method of claim 24, wherein the hearing device parameter optimizer is further configured to optimize at least one hearing device parameter based on estimated deviations between an effective hearing device gain and a prescribed hearing device gain.

26. The method of claim 14, further comprising using the computed displacement of the eardrum as an input for active noise control of a hearing device.

27. The method of claim 14, further comprising using the computed displacement of the eardrum as an input for active occlusion control of a hearing device.

28. The method of claim 27, further comprising:
sensing a reflected signal from an ear canal wall of the user using the optical sensor device;
measuring a bone-conducted voice component of the user using the reflected signal; and
using the measured bone-conducted voice component to enhance performance of the active occlusion control of the hearing device.

29. The method of claim 14, further comprising applying a reflective material to a face of the eardrum to provide an improved reflected light signal.

30. The method of claim 14, further comprising using a de-vibration coupling mechanism including splitting the coherent light signal to reflect from a side wall of an ear canal of the user.

31. The method of claim 14, further comprising using a half fringe stabilization system to provide negative feedback for linearization of measurement over a half wavelength of the coherent light signal.
